(19) United States
(12) Patent Application Publication
(10) Pub. No.: US 2018/0372927 A1
(43) Pub. Date: Dec. 27, 2018

(54) ELECTRONIC EYEGLASSES

(71) Applicant: Mitsui Chemicals, Inc., Minato-ku, Tokoyo (JP)

(72) Inventors: Ryuki KAN, Minato-ku, Tokoyo (JP); Akifumi AONO, Minato-ku, Tokoyo (JP)

(73) Assignee: Mitsui Chemicals, Inc., Minato-ku, Tokoyo (JP)

(21) Appl. No.: 16/062,055

(22) PCT Filed: Dec. 20, 2016
(86) PCT No.: PCT/JP2016/087995

§ 371 Date: Jun. 13, 2018

(30) Foreign Application Priority Data
Dec. 21, 2015 (JP) 2015-248922

(51) Int. Cl. G02B 3/14; G02C 7/06; G02F 1/13

(52) U.S. Cl. CPC G02B 3/14; G02F 2001/294; G02F 1/1313; G02C 7/06

(57) ABSTRACT

Provided are electronic eyeglasses capable of notifying a wearer that a usage mode is switched, without obstructing a visual field of the wearer. Electronic eyeglasses include a lens that has a liquid crystal region configured to be opacified by power supply, a control unit that controls an application voltage to be supplied to the liquid crystal region, and a switching operation unit for switching the usage mode. The liquid crystal region has an area smaller than a total area of the lens. In a case where the usage mode is switched from a first mode to a second mode by an operation of the switching operation unit, the control unit controls the application voltage to be supplied to the liquid crystal region so that the liquid crystal region is opacified in a specific aspect.

### BACKGROUND OF THE INVENTION

### Technical Field

The present invention relates to electronic eyeglasses.

### Background Art

In the related art, bifocal electronic eyeglasses have been proposed and have been put into practical use, which enables a focal length of a lens to be electrically controlled. In general, the electronic eyeglasses include a liquid crystal lens having a liquid crystal element configured so that a refractive index of the crystal element is changed by supplied power, a small battery for storing the power supplied to the liquid crystal lens, and a switch for performing a predetermined operation.

Currently, in a liquid crystal shutter glasses for stereoscopic display similar to these electronic eyeglasses, a technique has been proposed in which a liquid crystal shutter is opened and closed so as to notify a wearer of the eyeglasses that power supply is turned on or that a battery is flat (for example, refer to Patent Documents 1 and 2).

### CITATION LIST

### Patent Document

Patent Document 1: Japanese Patent Application Laid-Open No. 8-278468
Patent Document 2: Japanese Patent Application Laid-Open No. 9-90292

### SUMMARY

### Technical Problem

Incidentally, in recent years, a technique has been proposed in which a predetermined switch is operated so as to switch a usage mode of the electronic eyeglasses (for example, from a manual mode to an auto mode). However, up to now, effective means for enabling the wearer of the eyeglasses to recognize that the usage mode of the electronic eyeglasses is switched has not been proposed. If means as disclosed in Patent Documents 1 and 2 is adopted, the whole liquid crystal lens of the electronic eyeglasses is temporarily closed, thereby causing a problem in that a visual field of the wearer is obstructed.

The present invention is made in view of the above-described circumstances, and an object thereof is to provide electronic eyeglasses capable of notifying a wearer that a usage mode is switched, without obstructing a visual field of the wearer.

### Solution to Problem

In order to achieve the above-described object, electronic eyeglasses according to the present invention include a lens that has a liquid crystal region configured to be opacified by power supply, a control unit that controls an application voltage to be supplied to the liquid crystal region, and a switching operation unit for switching a usage mode. The liquid crystal region has an area smaller than a total area of the lens. In a case where the usage mode is switched from a first mode to a second mode by an operation of the switching operation unit, the control unit controls the application voltage to be supplied to the liquid crystal region so that the liquid crystal region is opacified in a specific aspect (for example, multiple times at a predetermined time interval).

If this configuration is adopted, in a case where the usage mode is switched from the first mode (for example, a manual mode) to the second mode (for example, an auto mode) by the operation of the switching operation unit, the control unit can control the application voltage to be supplied to the liquid crystal region so that the liquid crystal region is opacified in the specific aspect (for example, multiple times at a predetermined time interval). Therefore, a wearer of the electronic eyeglasses can recognize that the usage mode is switched from the first mode to the second mode by the opacified liquid crystal region of the lens in front of the wearer's eye. In this case, since the liquid crystal region has the area smaller than the total area of the lens, even if the liquid crystal region is opacified, the whole lens is not opacified. Therefore, it is possible to prevent a visual field of the wearer of the electronic eyeglasses from being obstructed.

In addition, a first eyewear having a plurality of modes according to the present invention includes a lens that has a liquid crystal region, and a control unit that controls an application voltage to be supplied to the liquid crystal region. The liquid crystal region has an area smaller than a total area of the lens. In a case where the control unit detects that a first mode is switched to a second mode out of the plurality of modes, the control unit controls the application voltage to be supplied to the liquid crystal region so that the liquid crystal region is opacified in a specific aspect. The eyewear may further include a switching operation unit for receiving the switching of the mode. In this case, in a case where the control unit is instructed to switch the first mode to the second mode by the operation of the switching operation unit, the control unit can control the application voltage to be supplied to the liquid crystal region so that the liquid crystal region is opacified multiple times at the predetermined time interval. As the first mode, a manual mode in which power supply/shutdown for the liquid crystal region is performed by the operation of the liquid crystal operation unit, may be adopted. As the second mode, an auto mode in which the power supply/shutdown for the liquid crystal region is automatically performed, may be adopted.

If this configuration is adopted, in a case where the mode is switched from the first mode (for example, the manual mode) to the second mode (for example, the auto mode) by the operation of the switching operation unit, the control unit can control the application voltage to be supplied to the liquid crystal region so that the liquid crystal region is opacified in the specific aspect (for example, multiple times at the predetermined time interval). Therefore, the wearer of the eyewear can recognize that the mode is switched from the first mode to the second mode by the opacified liquid crystal region of the lens in front of the wearer's eye. In this case, since the liquid crystal region has the area smaller than the total area of the lens, even if the liquid crystal region is opacified, the whole lens is not opacified. Therefore, it is possible to prevent the visual field of the wearer of the eyewear from being obstructed.

In the first eyewear according to the present invention, a touch sensor may be adopted as the switching operation unit. In this case, the control unit may be adopted as follows. Whereas the mode is switched from the first mode to the second mode in a case where a first operation is performed on the touch sensor, and the mode is switched from the second mode to the first mode in a case where a second operation is performed on the touch sensor.

If this configuration is adopted, whereas the mode is switched from the first mode to the second mode by performing the first operation (for example, a swipe operation) on the touch sensor, the mode is switched from the second mode to the first mode by performing the second operation on the touch sensor (for example, a touch operation).

In the first eyewear according to the present invention, a touch sensor may be adopted as the liquid crystal operation unit. In this case, the control unit may be adopted to perform power supply or shutdown on the liquid crystal region in a case where the touch operation is performed on the touch sensor during a period shorter than a predetermined time when the mode is the manual mode. In this case, the switching operation unit can also serve as the liquid crystal operation unit.

The first eyewear according to the present invention may further include an acceleration sensor that detects acceleration of electronic eyeglasses. In this case, when the mode is the auto mode, the control unit may be adopted to control the application voltage to be supplied to the liquid crystal region, based on a detection result obtained by the acceleration sensor.

In the first eyewear according to the present invention, the switching operation unit may be disposed in a temple.

In the first eyewear according to the present invention, the liquid crystal region may be disposed at a position close to an edge portion of the lens, and an area of the liquid crystal region may be set to be in a range of 5% to 50% of the total area of the lens.

If this configuration is adopted, the liquid crystal region is disposed at the position close to the edge portion of the lens, and the area of the liquid crystal region is set to be in the range of 5% to 50% of the total area of the lens. Accordingly, even if the liquid crystal region is opacified, it is possible to secure the visual field in the vicinity of the center of the lens.

The first eyewear according to the present invention may further include a battery that stores the power supplied to the liquid crystal region, and a power sensor that detects a power amount stored in the battery. In this case, the control unit may be adopted to control the application voltage to be supplied to the liquid crystal region so that the liquid crystal region is opacified in the specific aspect, in a case where the power amount detected by the power sensor is smaller than a predetermined threshold value.

If this configuration is adopted, in a case where the power amount (power amount stored in the battery) detected by the power sensor is smaller than the predetermined threshold value, the control unit can control the application voltage to be supplied to the liquid crystal region so that the liquid crystal region is opacified in the specific aspect. Therefore, the wearer of the electronic eyeglasses can recognize that the remaining power amount stored in the battery is small, by confirming the opacified liquid crystal region of the lens in front of the wearer's eye. In this case, even if the liquid crystal region is opacified, the whole lens is not opacified. Therefore, it is possible to prevent the visual field of the wearer of the electronic eyeglasses from being obstructed.

In addition, a second eyewear having a plurality of modes according to the present invention includes a lens that has an electrically active unit configured so that optical properties are changed by power supply, and a control unit that controls the optical properties of the electrically active unit. In a case where the control unit detects that a first mode is switched to a second mode out of the plurality of modes, the control unit causes the electrically active unit to change an aspect in the first mode to an aspect in the second mode, and when the aspect is changed, the control unit controls the optical properties of the electrically active unit so that the electrically active unit is visible in a specific aspect. The specific aspect in which the electrically active unit is visible may adopt an aspect in which the electrically active unit is visible by opacifying or coloring the electrically active unit, or by changing a transmittance rate of the electrically active unit. As the aspect in the first mode and the aspect in the second mode of the electronically active unit, an aspect in which the electronically active unit is in a substantially transparent state, may be adopted.

If this configuration is adopted, in a case where the control unit detects that the first mode (for example, the manual mode) is switched to the second mode (for example, the auto mode) out of the plurality of modes, the control unit can cause the electrically active unit to change an aspect in the first mode to an aspect in the second mode. Then, when the aspect is changed, the control unit can control the optical properties of the electrically active unit so that the electrically active unit is visible in a specific aspect (for example, an aspect in which the electrically active unit is visible by opacifying or coloring the electrically active unit, or by changing the transmittance rate of the electrically active unit). Therefore, the wearer of the eyewear can recognize that the mode is switched from the first mode to the second mode, by confirming the electrically active unit of the lens in front of the wearer's eye.

The second eyewear according to the present invention may further include a switching operation unit that receives an operation of a user. In this case, the control unit may be adopted to detect that the first mode is switched to the second mode, in accordance with the operation performed on the switching operation unit by the user. In addition, the control unit may be adopted to detect that the first mode is switched to the second mode, without receiving the operation of the user.

The second eyewear according to the present invention may further include a posture detection sensor. In this case, the control unit may be adopted to detect that the first mode is switched to the second mode, based on a detection result obtained by the posture detection sensor.

In the second eyewear according to the present invention, as the first mode and the second mode, a usage mode or a power mode of the eyewear may be adopted.

In the second eyewear according to the present invention, as the first mode and the second mode, a mode relating to a first parameter may be adopted. In this case, the aspect in the first mode and the aspect in the second mode may be determined by a second parameter which is different from the first parameter. As the mode relating to the first parameter, a usage mode or a power mode of the eyewear may be adopted. As the second parameter, battery remaining capacity of the eyewear may be adopted.

### Advantageous Effects of Invention

According to the present invention, it is possible to provide electronic eyeglasses capable of notifying a wearer that a usage mode is switched, without obstructing a visual field of the wearer.

### BRIEF DESCRIPTION OF DRAWINGS

FIG. 1 is an overall perspective view of electronic eyeglasses according to an embodiment of the present invention.

FIG. 2 is a view for describing a liquid crystal region of a lens of the electronic eyeglasses according to the embodiment of the present invention.

FIG. 3 is a flowchart for describing mode switching display control (switching from a manual mode to an auto mode) performed by an electronic control module of the electronic eyeglasses according to the embodiment of the present invention.

FIG. 4 is a flowchart for describing mode the switching display control (switching from the auto mode to the manual mode) performed by the electronic control module of the electronic eyeglasses according to the embodiment of the present invention.

### DESCRIPTION OF EMBODIMENTS

Hereinafter, an embodiment according to the present invention will be described with reference to the drawings. The following embodiment is merely a preferable application example, and the scope of application of the present invention is not limited thereto.

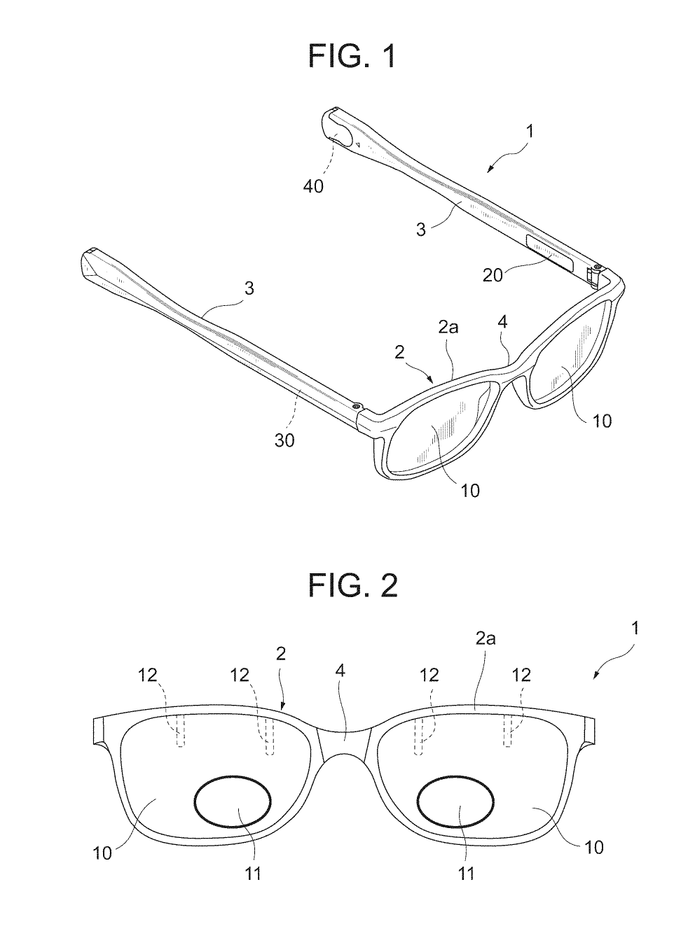

First, referring to FIGS. 1 and 2, a configuration of electronic eyeglasses 1 according to the embodiment of the present invention will be described.

The electronic eyeglasses 1 according to the present embodiment include lenses 10 that have a liquid crystal region (electrically active unit) 11, an electronic control module 20 (control unit) that controls power supply to the liquid crystal region 11, and a touch sensor 30 for switching a usage mode. In the present embodiment, as illustrated in FIGS. 1 and 2, the lens 10 is supported by a frame 2a of a front part 2, and the electronic control module 20 and the touch sensor 30 are embedded in temples 3 pivotably attached to the frame 2a via a hinge. The electronic control module 20 and the touch sensor 30 may be disposed in only one (for example, a right side) of the temples 3, or may be disposed in both the (right and left) temples 3.

A pair of the right and left lenses 10 each has a lens electrode 12 as illustrated in FIG. 2. A voltage is applied to or removed from the liquid crystal region 11 via the lens electrode 12. In this manner, a refractive index of the liquid crystal region 11 can be changed, and further, a focal length can be changed. In addition, the liquid crystal region 11 has the optical properties that the liquid crystal region 11 is opacified when the voltage is applied thereto. In the present embodiment, controlling an application voltage to be supplied to the liquid crystal region 11 so as to control the optical properties of the liquid crystal region 11 is expressed as controlling the power supply to the liquid crystal region 11, in some case. The electronic eyeglasses 1 according to the present embodiment can notify a wearer that the usage mode is switched, by using the optical properties of the liquid crystal region 11.

As illustrated in FIG. 2, the liquid crystal region 11 of the lens 10 is disposed at a position close to a lower edge portion of the lens 10, and has an area smaller than a total area of the lens 10. The area of the liquid crystal region 11 can be set to be in a range of approximately 5% to 50% (preferably, approximately 12% to 13%) of the total area of the lens 10.

The electronic control module 20 has a circuit board (not illustrated) having various circuits mounted thereon, and a capacitance type of the touch sensor 30 is connected to the circuit board. In the present embodiment, the circuit board is disposed inside the temple 3, and the touch sensor 30 is disposed outside the temple 3, thereby enabling the wearer of the electronic eyeglasses 1 to easily operate the touch sensor 30. The electronic control module 20 controls power supply to the liquid crystal region 11, based on an operation of the touch sensor 30, and functions as a control unit according to the present invention. Specific control content performed by the electronic control module 20 will be described in detail later. The touch sensor 30 switches the usage mode of the electronic eyeglasses 1 (from a manual mode to an auto mode, and from the auto mode to the manual mode), and functions as a switching operation unit according to the present invention. The manual mode represents a mode in which power supply/shutdown of the liquid crystal region 11 is performed by an operation of the touch sensor 30, and corresponds to a first mode according to the present invention. On the other hand, the auto mode represents a mode in which the power supply/shutdown of the liquid crystal region 11 is automatically performed, and corresponds to a second mode according to the present invention.

In addition, the electronic eyeglasses 1 according to the present embodiment include an acceleration sensor (not illustrated) that detects own acceleration thereof. A detection result obtained by the acceleration sensor is used by the electronic control module 20 when the power supply to the liquid crystal region 11 is controlled in the auto mode.

In addition, the electronic eyeglasses 1 according to the present embodiment includes a battery 40 that stores power to be supplied to the liquid crystal region 11 of the lens 10, and a power sensor (not illustrated) that detects a power amount stored in the battery 40. In the present embodiment, as illustrated in FIG. 1, the battery 40 is embedded in an end portion of the temple 3. A detection result obtained by the power sensor is used by the electronic control module 20 when the power supply to the liquid crystal region 11 is controlled. The battery 40 may be disposed in the end portion of one (for example, a left side) of the temples 3, or may be disposed in the end portion of both the (right and left) temples 3.

Next, the specific control content performed by the electronic control module 20 of the electronic eyeglasses 1 according to the present embodiment will be described.

In a case where a swipe operation (first operation) is performed on the touch sensor 30 when the usage mode is the manual mode, the electronic control module 20 of the electronic eyeglasses 1 switches the usage mode from the manual mode to the auto mode. In this case, the electronic control module 20 controls the power supply to the liquid crystal region 11 so that the liquid crystal region 11 is opacified in a specific aspect (for example, multiple times at a predetermined time interval (for example, 0.25 seconds)). In the manual mode before the swipe operation is received and in the auto mode after the switching operation is performed, the liquid crystal region 11 is in a substantially transparent state. Therefore, the wearer can recognize that the liquid crystal region 11 is opacified.

In addition, in a case where a touch operation (second operation) is performed on the touch sensor 30 during a period exceeding a predetermined time (for example, 1 second) when the usage mode is the auto mode, the electronic control module 20 switches the usage mode from the auto mode to the manual mode. In this case, the electronic control module 20 controls the power supply to the liquid crystal region 11 so that the liquid crystal region 11 is opacified in a specific aspect (for example, only once at a predetermined time interval (for example, 0.5 seconds)). An aspect in which the liquid crystal region 11 is opacified when the auto mode is switched to the manual mode may be the same as or may be different from an aspect in which the liquid crystal region 11 is opacified when the manual mode is switched to the auto mode. In the auto mode before the touch operation is received and in the manual mode after the switching operation is received, the liquid crystal region 11 is in a substantially transparent state. Therefore, the wearer can recognize that the liquid crystal region 11 is opacified.

In addition, in a case where the touch operation is performed on the touch sensor 30 during a period equal to or shorter than the predetermined time (for example, 1 second) when the usage mode is the manual mode, the electronic control module 20 performs power supply or shutdown on the liquid crystal region 11. In this case, the touch sensor 30 functions as a liquid crystal operation unit for performing power supply/shutdown on the liquid crystal region 11 in the manual mode.

In addition, when the usage mode is the auto mode, the electronic control module 20 controls the power supply to the liquid crystal region 11, based on a detection result obtained by the acceleration sensor. For example, the electronic control module 20 supplies the power to the liquid crystal region 11, in a case where acceleration indicating that the wearer faces down is detected by the acceleration sensor. In this manner, the electronic control module 20 can change a refractive index of the liquid crystal region 11 to be a myopic correction value. On the other hand, the electronic control module 20 shuts down the power to be supplied to the liquid crystal region 11 when acceleration indicating that the wearer faces upward is detected by the acceleration sensor. In this manner, the electronic control module 20 can cause the refractive index of the liquid crystal region 11 to return to a default value.

In addition, in a case where the power amount of the battery 40 which is detected by the power sensor is smaller than a predetermined threshold value, the electronic control module 20 controls the power supply to the liquid crystal region 11 so that the liquid crystal region 11 is opacified in a specific aspect (for example, multiple times or always at a predetermined time interval (for example, 0.5 seconds)). In this manner, the wearer of the electronic eyeglasses 1 can recognize that the remaining power amount stored in the battery 40 is small. A plurality of threshold values for determining the power amount may be set in advance so as to change an opacified aspect in accordance with a level of the power amount. For example, in a case where the power amount of the battery 40 is smaller than a first threshold value, the liquid crystal region 11 can be opacified multiple times at the predetermined time interval. In a case where the power amount of the battery 40 is smaller than a second threshold value (which is smaller than the first threshold value), the liquid crystal region 11 can be always opacified.

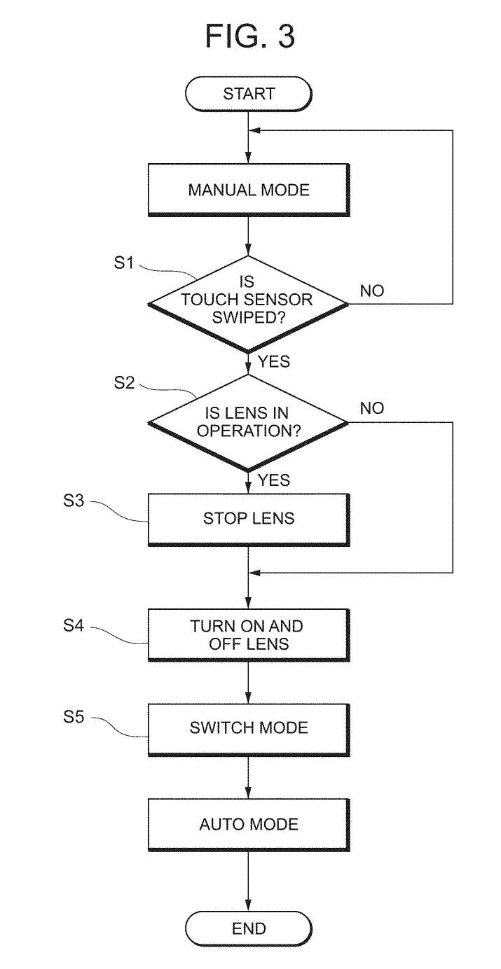

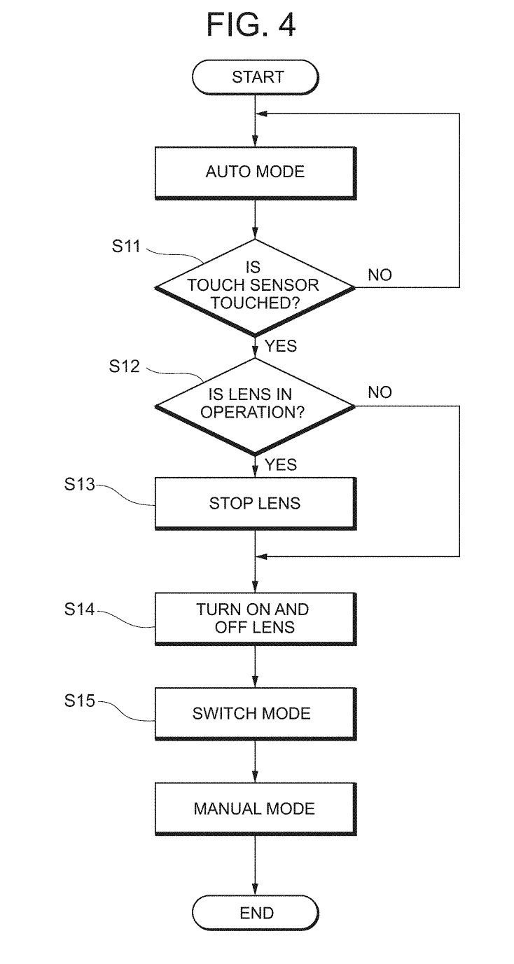

Subsequently, an example of mode switching display control performed by the electronic control module 20 of the electronic eyeglasses 1 according to the present embodiment will be described in detail with reference to flowcharts in FIGS. 3 and 4.

### <Switching Manual Mode to Auto Mode>

First, the switching display control when the usage mode of the electronic eyeglasses 1 is switched from the manual mode to the auto mode will be described with reference to the flowchart in FIG. 3.

In a case where the usage mode of the electronic eyeglasses 1 is the manual mode, the electronic control module 20 determines whether a swipe operation (first operation) is performed on the touch sensor 30 (swipe determination step: S1). Then, in a case where it is determined that the swipe operation is performed in the swipe determination step S1, the electronic control module 20 determines whether or not the power is supplied to the liquid crystal region 11 of the lens 10 (lens operation determination step: S2). In a case where it is determined that the power is supplied to the liquid crystal region 11, the electronic control module 20 temporarily stops the power supply to the liquid crystal region 11 (lens stopping step: S3).

The electronic control module 20 which completes the lens stopping step S3 controls the power supply to the liquid crystal region 11 so that the liquid crystal region 11 is opacified multiple times at a predetermined time interval (for example, 0.25 seconds) (lens turning-on/off step: S4). Thereafter, the electronic control module 20 switches the usage mode of the electronic eyeglasses 1 from the manual mode to the auto mode (mode switching step: S5), and based on the detection result obtained by the acceleration sensor, the electronic control module 20 controls the power supply to the liquid crystal region 11.

### <Switching Auto Mode to Manual Mode>

Next, switching display control when the usage mode of the electronic eyeglasses 1 is switched from the auto mode to the manual mode will be described with reference to the flowchart in FIG. 4.

In a case where the usage mode of the electronic eyeglasses 1 is the auto mode, the electronic control module 20 determines whether or not a touch operation (second operation) is performed on the touch sensor 30 during a period exceeding the predetermined time (for example, 1 second) (touch determination step: S11). Then, in a case where it is determined that the touch operation is performed during the period exceeding the predetermined time in the touch determination step S11, the electronic control module 20 determines whether or not the power is supplied to the liquid crystal region 11 of the lens 10 (lens operation determination step: S12). In a case where it is determined that the power is supplied to the liquid crystal region 11, the electronic control module 20 temporarily stops the power supply to the liquid crystal region 11 (lens stopping step: S13).

The electronic control module 20 which completes the lens stopping step S13 controls the power supply to the liquid crystal region 11 so that the liquid crystal region 11 is opacified only once at a predetermined time interval (for example, 0.5 seconds) (lens turning-on step: S14). Thereafter, the electronic control module 20 switches the usage mode of the electronic eyeglasses 1 from the auto mode to the manual mode (mode switching step: S15), and based on the touch operation performed on the touch sensor 30, the electronic control module 20 controls the power supply to the liquid crystal region 11.

In the electronic eyeglasses 1 according to the above-described embodiment, in a case where the usage mode is switched from the manual mode to the auto mode by performing the swipe operation on the touch sensor 30, the electronic control module 20 can control the power supply to the liquid crystal region 11 so that the liquid crystal region 11 is opacified in a specific aspect (for example, multiple times at a predetermined time interval). Therefore, the wearer of the electronic eyeglasses 1 can recognize that the usage mode is switched from the manual mode to the auto mode by confirming the opacified liquid crystal region 11 of the lens 10 in front of the wearer's eye. In this case, the liquid crystal region 11 has the area smaller than the total area of the lens 10. Accordingly, even if the liquid crystal region 11 is opacified, the whole lens 10 is not opacified. Therefore, it is possible to prevent the visual field of the wearer of the electronic eyeglasses 1 from being obstructed.

In addition, in the electronic eyeglasses 1 according to the above-described embodiment, even in a case where the usage mode is switched from the auto mode to the manual mode by performing the touch operation on the touch sensor 30, the electronic control module 20 can control the power supply to the liquid crystal region 11 so that the liquid crystal region 11 is opacified in a specific aspect (for example, only once at a predetermined time interval). Therefore, the wearer of the electronic eyeglasses 1 can recognize that the usage mode is switched from the auto mode to the manual mode, by confirming the opacified liquid crystal region 11 of the lens 10 in front of the wearer's eye. In this case, even if the liquid crystal region 11 is opacified, the whole lens 10 is not opacified. Accordingly, it is possible to prevent the visual field of the wearer of the electronic eyeglasses 1 from being obstructed. In addition, the specific aspect (for example, only once at the predetermined time interval) of the liquid crystal region 11 in a case where the auto mode is switched to the manual mode, and the specific aspect (for example, multiple times at the predetermined time interval) of the liquid crystal region 11 in a case where the manual mode is switched to the auto mode respectively represent an aspect in which the liquid crystal region 11 is visible, and mutually different aspects. In this manner, the wearer can identify any changed mode by performing the switch operation.

In addition, in the electronic eyeglasses 1 according to the above-described embodiment, the liquid crystal region 11 is disposed at a position close to a lower edge portion of the lens 10, and the area of the liquid crystal region 11 is set to be in a range of 5% to 50% of the total area of the total area of the lens 10. Accordingly, even in a case where the liquid crystal region 11 is opacified, it is possible to secure the visual field in the vicinity of the center of the lens 10.

In addition, in the electronic eyeglasses 1 according to the above-described embodiment, in a case where the power amount (power amount stored in the battery 40) detected by the power sensor is smaller than a predetermined threshold value, the electronic control module 20 can control the power supply to the liquid crystal region 11 so that the liquid crystal region 11 is opacified in a specific aspect. Therefore, the wearer of the electronic eyeglasses 1 can recognize that the remaining power amount stored in the battery 40 is small, by confirming the opacified liquid crystal region 11 of the lens 10 in front of the wearer's eye. In this case, even if the liquid crystal region 11 is opacified, the whole lens 10 is not opacified. Therefore, it is possible to prevent the visual field of the wearer of the electronic eyeglasses 1 from being obstructed.

In the above-described embodiment, an example has been described in which the touch sensor 30 disposed in the temple 3 of the electronic eyeglasses 1 is adopted as the switching operation unit. However, the configuration of the switching operation unit is limited thereto. For example, the switching operation unit may be disposed in a hinge for connecting the frame 2a and the temple 3 to each other. In addition, a mechanical switch can be adopted as the switching operation unit so that the mechanical switch is disposed in a bridge 4 (refer to FIGS. 1 and 2) of the front part 2 of the electronic eyeglasses 1. In addition, the mechanical switch may also serve as the liquid crystal operation unit. In a case where the mechanical switch is adopted as the switching operation unit, the electronic control module 20 can be configured to perform various controlling operations in accordance with an operation performed on the mechanical switch.

For example, the electronic control module 20 can be configured as follows. In a case where the first operation is performed on the mechanical switch, the electronic control module 20 switches the usage mode from the manual mode to the auto mode. In this case, the electronic control module 20 controls the power supply to the liquid crystal region 11 so that the liquid crystal region 11 is opacified in a specific aspect. On the other hand, the electronic control module 20 can be configured as follows. In a case where the second operation is performed on the mechanical switch, the electronic control module 20 controls the power supply to switches the usage mode from the auto mode to the manual mode. In this case, the liquid crystal region 11 controls the power supply to the liquid crystal region 11 so that the liquid crystal region 11 is opacified in a specific aspect. In addition, in a case where a third operation performed on in the mechanical switch when the usage mode is the manual mode, the electronic control module 20 may be configured to perform power supply or shutdown of the liquid crystal region 11.

In addition, in the above-described embodiment, an example has been described in which the touch sensor 30 functions as the switching operation unit and the liquid crystal operation unit. However, the touch sensor 30 and the mechanical switch can be used in combination. While one (for example, the touch sensor 30) may function as the switching operation unit, the other (for example, the mechanical switch) may function as the liquid crystal operation unit.

In addition, in the above-described embodiment, an aspect in which the liquid crystal region 11 is opacified when the mode is switched has been described as an example. However, other aspects can also be adopted. In the case where the liquid crystal region 11 is opacified, light is scattered by the liquid crystal region 11 so as to change the transmittance rate. However, for example, an electrochromic material (electronically active unit) which is changed from an almost transparent state to a colored state of an orange color or a blue color by applying an electric field or a current thereto may be disposed in the liquid crystal region 11 inside the lens of the electronic eyeglasses, or in a region other than the liquid crystal region 11 inside the lens. The electrochromic material may be liquid crystal or other materials. In a case where the usage mode is switched from the auto mode to the manual mode, the control unit (electronic control module 20) can control the power supply to the electrochromic material so that the electrochromic material is colored in a first aspect (for example, only once at a predetermined time interval). In a case where the usage mode is switched from the manual mode to the auto mode, the control unit can control the power supply to the electrochromic material so that the electrochromic material can be colored in a second aspect (for example, multiple times at a predetermined time interval). In addition, in a case where the usage mode is switched from the auto mode to the manual mode, the control unit can control the power supply to the electrochromic material so that the electrochromic materials colored in a first color (for example, an orange color). In a case where the usage mode is switched from the manual mode to the auto mode, the control unit can control the power supply to the electrochromic material so that the electrochromic material is colored in a second color (for example, a blue color). In this way, based on a specific colored state of the lens, the wearer can identify that the usage mode is switched.

In addition, in the above-described embodiment, an example has been described in which the liquid crystal region 11 is disposed at only one position close to the lower edge portion of each lens 10. However, a plurality of the liquid crystal regions 11 can be disposed for each lens 10 so as to selectively determine the liquid crystal region 11 to be changed to a specific state depending on a switching destination of the usage mode. For example, the liquid crystal regions 11 may be separately disposed at a left position close to the edge portion and a right position close to the edge portion of each lens 10. In a case where the usage mode is switched from the auto mode to the manual mode, the control unit (electronic control module 20) may opacify the liquid crystal region 11 on the left side of each lens 10 in the first aspect. In a case where the usage mode is switched from the manual mode to the auto mode, the control unit may opacify the liquid crystal region 11 on the right side of each lens 10 in the second aspect. In this case, the places of the right and left liquid crystal regions 11 are different from each other, and the wearer can identify the mode of the changed destination at the place inside the lens 10. Therefore, the right and left liquid crystal regions 11 may be opacified in the same aspect.

In addition, in the above-described embodiment, an example has been described in which the usage mode is switched by the wearer operating the touch sensor 30. However, based on the detection result obtained by the acceleration sensor, the usage mode can be switched from the first mode to the second mode. In addition, based on the detection result detected by the acceleration sensor, the liquid crystal region 11 is opacified in a specific aspect. In this manner, the wearer can be notified of a change in the refractive index. For example, when the usage mode is the auto mode, in a case where the acceleration indicating that the wearer faces downward is detected by the acceleration sensor, the control unit (electronic control module 20) can supply the power to the liquid crystal region 11 so that the liquid crystal region 11 is opacified in a specific aspect. Thereafter, the control unit can change the refractive index of the liquid crystal region 11 to a myopic correction value. On the other hand, in a case where the acceleration indicating that the wearer faces upward is detected by the acceleration sensor, the control unit can supply the power to the liquid crystal region 11 so that the liquid crystal region 11 is opacified in a specific aspect. Thereafter, the control unit can shut down the power supply to the liquid crystal region 11, and can control the refractive index of the liquid crystal region 11 to return to a default value. In this manner, in a case where the optical properties of the liquid crystal region 11 are automatically switched during the auto mode, the wearer can recognize that the liquid crystal region 11 is opacified in a specific aspect.

An example has been described in which an orientation of the wearer's head is detected by the acceleration sensor. However, without being limited to only the acceleration sensor, a posture of the wearer can be detected by using various sensors for detecting the posture such as an angular velocity sensor and a gyro sensor. The control unit (electronic control module 20) can control the liquid crystal region 11 to be opacified in accordance with the detection result of the posture detection sensor.

In addition, in the above-described embodiment, an example has been described in which the usage mode (the manual mode and the auto mode) of the electronic eyeglasses 1 is adopted as the plurality of modes. However, a power mode (a power-on mode, a sleep mode, and power-off mode) of the electronic eyeglasses 1 can be adopted as the plurality of modes. The control unit (electronic control module 20) can control the liquid crystal region 11 to be opacified in a predetermined aspect when the power modes are switched therebetween. In the power-on mode, the power is supplied to various sensors such as the touch sensor 30. In this manner, the liquid crystal region 11 can be controlled by receiving the switching operation in the usage mode from the wearer. In the sleep mode, compared to the power-on mode, some functions of the electronic eyeglasses 1 are turned off to save the power (for example, the touch sensor 30 does not function in this mode). In the power-off mode, all functions of the electronic eyeglasses 1 are turned off. The control unit performs control so that the power-on mode is switched to the sleep mode when the acceleration sensor detects that the wearer does not wear the electronic eyeglasses 1 for a predetermined period of time in the power-on mode. In this case, the liquid crystal region 11 is opacified in a specific aspect. That is, when a predetermined condition is satisfied without depending on the operation performed on the touch sensor 30 by the wearer, the liquid crystal region 11 is opacified by the control unit, and the power mode is switched from the power-on mode to the sleep mode. In this manner, even in a case where the mode is changed without depending on the wearer's own explicit operation, the wearer can recognize the changed mode by confirming that liquid crystal region 11 is changed to a specific aspect.

In addition, it is possible to adopt a combination of different modes. For example, in the power mode relating to the power supply (first parameter), when one of the three modes of the power-on mode, the sleep mode, and the power-off mode is switched to the other state, a liquid crystal state may be changed to a visible specific aspect. Based on battery remaining capacity (second parameter), the specific aspect may be changed. For example, when the switch operation from the power-on mode to the sleep mode is received, the control unit (electronic control module 20) can measure the battery remaining capacity, and can determine a level of the battery remaining capacity as level I (high: 50% to 100%), level II (low: 20% and lower than 50%), level III (charging required: lower than 20%). The control unit can perform control so that the liquid crystal regions 11 are opacified in mutually different aspects in accordance with level I to level III of the measured remaining battery capacity (for example, in a case of level I, the liquid crystal region 11 is opacified once, in a case of level II, the liquid crystal region 11 is opacified twice, and in a case of level III, the liquid crystal region 11 is opacified 3 times).

Similarly, even in a case where the switch operation of the usage mode from one mode to the other mode is received, the control unit can measure the battery remaining capacity, and can control the liquid crystal region 11 in an aspect corresponding to the battery remaining capacity. In this way, the liquid crystal region 11 is opacified, thereby enabling the wearer to recognize that the power mode (or the usage mode) is changed. The wearer can recognize the level of the battery remaining capacity by confirming the number of times that the liquid crystal region 11 is opacified. That is, since the liquid crystal region 11 is opacified in the specific aspect, the wearer can recognize information relating to the two parameters such as the power supply and the battery remaining capacity (or a usage state and the battery remaining capacity).

In addition, in the above-described embodiment, an example has been described in which the electronic eyeglasses 1 are adopted as the eyewear. However, the eyewear to which the present invention is applied is not limited thereto, and may be applied to any eyewear worn by the vicinity of a user's head, ear, or eye. Examples of the eyewear include so-called eyeglasses (including the electronic eyeglasses) having an auxiliary mechanism for improving the vision of the user, such as the lens, and various devices having a mechanism for presenting information to the user's visual field or eye (for example, an eyeglass-type wearable terminal or a head mount display).

The present invention is not limited to the above-described embodiment. As long as any additional design change in this embodiment which is appropriately made by those skilled in the art includes the characteristics of the present invention, the additional design change falls within the scope of the present invention. That is, the respective elements, arrangement, materials, conditions, shapes, and sizes which are included in the above-described embodiment are not limited to those which have been described above as examples, and can be appropriately modified. In addition, the respective elements included in the above-described embodiment can be combined with each other as long as those are technically available, and a combination thereof also falls within the scope of the present invention as long as the combination includes the characteristics of the present invention.

### REFERENCE SIGNS LIST

1: electronic eyeglasses (eyewear)
3: temple
10: lens
11: liquid crystal region (electronically active unit)
20: electronic control module (control unit)
30: touch sensor (switching operation unit, liquid crystal operation unit)
40: battery

1. An eyewear having a plurality of modes, comprising:
a lens that has a liquid crystal region; and
a control unit that controls an application voltage to be supplied to the liquid crystal region,
wherein the liquid crystal region has an area smaller than a total area of the lens, and
wherein, in a case where the control unit detects that a first mode is switched to a second mode out of the plurality of modes, the control unit controls the application voltage to be supplied to the liquid crystal region so that the liquid crystal region is opacified in a specific aspect.

2. The eyewear according to claim 1, further comprising:
a switching operation unit for receiving the switching of the mode,
wherein, in a case where the switching from the first mode to the second mode is instructed by an operation of the switching operation unit, the control unit controls the application voltage to be supplied to the liquid crystal region so that the liquid crystal region is opacified multiple times at a predetermined time interval.

3. The eyewear according to claim 2,
wherein the switching operation unit is a touch sensor, and
wherein, whereas the control unit switches the mode from the first mode to the second mode in a case where a first operation is performed on the touch sensor, the control unit switches the mode from the second mode to the first mode in a case where a second operation is performed on the touch sensor.

4. The eyewear according to claim 2,
wherein the switching operation unit functions as a liquid crystal operation unit.

5. The eyewear according to claim 4,
wherein the first mode is a manual mode in which power supply/shutdown is performed on the liquid crystal region by an operation of the liquid crystal operation unit, and
wherein the second mode is an auto mode in which the power supply/shutdown is automatically performed on the liquid crystal region.

6. The eyewear according to claim 5,
wherein the liquid crystal operation unit is a touch sensor,
wherein, in a case where a touch operation is performed on the touch sensor during a period shorter than a predetermined time when the mode is the manual mode, the control unit performs power supply or shutdown on the liquid crystal region.

7. The eyewear according to claim 5, further comprising:
an acceleration sensor that detects acceleration of the electronic eyeglasses,
wherein, when the mode is the auto mode, the control unit controls the application voltage to be supplied to the liquid crystal region, based on a detection result obtained by the acceleration sensor.

8. The eyewear according to claim 2,
wherein the switching operation unit is disposed in a temple.

9. The eyewear according to claim 1,
wherein the liquid crystal region is disposed at a position close to an edge portion of the lens, and
wherein an area of the liquid crystal region is set to be in a range of 5% to 50° % of the total area of the lens.

10. The eyewear according to claim 1, further comprising:
a battery that stores power to be supplied to the liquid crystal region; and
a power sensor that detects a power amount stored in the battery,
wherein, in a case where the power amount detected by the power sensor is smaller than a predetermined threshold value, the control unit controls the application voltage to be supplied to the liquid crystal region so that the liquid crystal region is opacified in a specific aspect.

11. Electronic eyeglasses comprising:
a lens that has a liquid crystal region configured to be opacified by power supply;
a control unit that controls an application voltage to be supplied to the liquid crystal region; and
a switching operation unit for switching a usage mode,
wherein the liquid crystal region has an area smaller than a total area of the lens, and
wherein, in a case where the usage mode is switched from a first mode to a second mode by an operation of the switching operation unit, the control unit controls the application voltage to be supplied to the liquid crystal region so that the liquid crystal region is opacified in a specific aspect.

12. An eyewear having a plurality of modes, comprising:
a lens that has an electrically active unit configured so that optical properties are changed by power supply; and
a control unit that controls the optical properties of the electrically active unit,
wherein, in a case where the control unit detects that a first mode is switched to a second mode out of the plurality of modes, the control unit causes the electrically active unit to change an aspect in the first mode to an aspect in the second mode, and when the aspect is changed, the control unit controls the optical properties of the electrically active unit so that the electrically active unit is visible in a specific aspect.

13. The eyewear according to claim 12,
a switching operation unit that receives an operation of a user,
wherein, in accordance with the operation performed on the switching operation unit by the user, the control unit detects that the first mode is switched to the second mode.

14. The eyewear according to claim 12,
wherein, without receiving the operation of the user, the control unit detects that the first mode is switched to the second mode.

15. The eyewear according to claim 14, further comprising:
a posture detection sensor,
wherein, based on a detection result obtained by the posture detection sensor, the control unit detects that the first mode is switched to the second mode.

16. The eyewear according to claim 12,
wherein the specific aspect in which the electrically active unit is visible represents an aspect in which the electrically active unit is visible by opacifying or coloring the electrically active unit, or by changing a transmittance rate of the electrically active unit.

17. The eyewear according to claim 12,
wherein the first mode and the second mode represents a usage mode or a power mode of the eyewear.

18. The eyewear according to claim 12,
wherein the first mode and the second mode represents a mode relating to a first parameter, and
wherein the aspect in the first mode and the aspect in the second mode are determined by a second parameter which is different from the first parameter.

19. The eyewear according to claim 18,
wherein the mode relating to the first parameter represents a usage mode or a power mode of the eyewear, and
wherein the second parameter represents battery remaining capacity of the eyewear.

20. The eyewear according to claim 12,
wherein the aspect in the first mode and the aspect in the second mode of the electronically active unit represent an aspect in which the electronically active unit is in a substantially transparent state.
